(19) United States
(12) Patent Application Publication
(10) Pub. No.: US 2026/0290949 A1
(43) Pub. Date: Sep. 24, 2026

(54) METHOD FOR PRODUCING A PRISMATIC BATTERY CELL

(71) Applicant: PowerCo SE, Salzgitter (DE)

(72) Inventors: Bjoern LOEHR, Werlaburgdorf (DE); Marius EBBIGHAUSEN, Braunschweig (DE); Natascha VON ASPERN, Braunschweig (DE); Lukas KWOCZEK, Salzgitter (DE)

(73) Assignee: PowerCo SE, Salzgitter (DE)

(21) Appl. No.: 19/676,047

(22) Filed: May 13, 2026

Related U.S. Application Data
(63) Continuation of application No. PCT/EP2024/082066, filed on Nov. 12, 2024.

(30) Foreign Application Priority Data
Nov. 13, 2023 (DE) 10 2023 211 201.9

(51) Int. Cl. H01M 50/103; H01M 10/0525; H01M 10/0585; H01M 50/169; H01M 50/536; H01M 50/54; H01M 50/566; H01M 50/593

(52) U.S. Cl. CPC H01M 50/103; H01M 10/0525; H01M 10/0585; H01M 50/169; H01M 50/536; H01M 50/54; H01M 50/566; H01M 50/593; H01M 2220/20

(57) ABSTRACT

A method for manufacturing a prismatic battery cell. An electrode stack having first electrodes and second electrodes are stacked one on top of the other. Arresters of the first electrodes rise up at an end-face side of the electrode arrangement. Arresters of the first electrodes are compacted, the compacted arresters are welded to a contact plate. The contact plate is welded to a contact element of a cell cover. A prismatic battery cell is also provided.

This nonprovisional application is a continuation of International Application No. PCT/EP2024/082066, which was filed on Nov. 12, 2024, and which claims priority to German Patent Application No. 10 2023 211 201.9, which was filed in Germany on Nov. 13, 2023, and which are both herein incorporated by reference.

### BACKGROUND OF THE INVENTION

### Field of the Invention

The invention relates to a method for manufacturing a prismatic battery cell, in which arresters of the first electrodes thereof are compacted and welded to a contact plate. The invention further relates to a prismatic battery cell that is manufactured according to the method.

### Description of Background Art

An electrically driven motor vehicle typically has a traction battery (high-voltage (HV) battery) that supplies an electric motor with energy for driving the motor vehicle. An electrically driven motor vehicle is understood in particular to mean an electric vehicle that stores the necessary energy for the drive only in the traction battery (battery electric vehicle (BEV), a range-extended electric vehicle (REEV), a hybrid electric vehicle (HEV), a plug-in hybrid electric vehicle (PHEV), and/or a fuel cell electric vehicle (FCEV) that temporarily stores the electrical energy, generated by means of a fuel cell, in the traction battery.

Such a traction battery typically includes multiple battery cells, in particular lithium-ion battery cells, that are electrically interconnected in series and/or in parallel.

The battery cells are divided into different classes or types, depending on their design. Thus, for example, a pouch cell (coffee bag cell) has a foil, in particular an aluminum composite foil, as a casing in which the electrodes of the battery cell are enclosed. In contrast, a cylindrical battery cell includes a comparatively rigid housing, in particular made of sheet metal, with the housing having an essentially circular cylindrical shape. Furthermore, so-called prismatic battery cells are known which have a housing that is likewise comparatively rigid, in particular made of sheet metal and essentially cuboidal.

A battery cell is known from US 2012/0171568 A1. This battery cell includes a plurality of electrode films, a terminal that is welded to the plurality of electrodes, and a buffer film that is welded to the plurality of electrodes, with the plurality of electrodes being situated between the terminal and the buffer film.

A battery with an electrode body and an internal terminal is disclosed in U.S. Pat. No. 11,158,914 B2. The electrode body includes positive and negative electrode sheets. The internal terminal includes a connector that is connected to the protruding sections of the electrode sheets. The protruding sections are bent around a base end.

U.S. Pat. No. 9,935,305 B2 describes a secondary battery having a battery device that is packaged by an exterior material. The battery device includes a positive electrode and a negative electrode, with a positive tab electrically connected to the positive electrode and led out to the outer side of the exterior material. A negative tab is electrically connected to the negative electrode and led out to the outer side of the exterior material.

### SUMMARY OF THE INVENTION

It is therefore an object of the present invention to provide a particularly suitable method for manufacturing a prismatic battery cell. Such a battery cell and an electrically driven motor vehicle having such a battery cell are also provided.

The examples and below discussion regarding the method also analogously apply to the battery cell, and vice versa.

The method is used to manufacture a prismatic battery cell. This prismatic battery cell is advantageously designed as a lithium-ion battery cell. The battery cell is preferably provided and configured for a traction battery of an electrically driven motor vehicle.

Firstly, an electrode stack is provided, which in a direction referred to here and in the following discussion as a stacking direction or a vertical stacking direction, has first electrodes and second electrodes stacked one on top of the other. Thus, the electrode stack is formed based on a number of first electrodes and a number of second electrodes, with the electrodes arranged one on top of the other in the stacking direction. The first and second electrodes are advantageously arranged in alternation, with a separator being situated between each first electrode and the second electrode neighboring it.

Each of the first electrodes can be designed, for example, as a cathode, and each of the second electrodes is designed, for example, as an anode.

Each electrode suitably can have a sheet-like design. The particular electrode is formed by means of a foil-like substrate that in particular is made of a metal foil. The particular substrate includes a (first) section that is coated with an active material, and an arrester, in particular integrally formed on this section, as a second section. The arrester is also referred to as a lug. The coated section of the substrate of each of the electrodes advantageously has a rectangular, in particular nonsquare, base area. In the electrode stack, each first section of the electrodes spans a surface area perpendicular to the stacking direction.

The arrester can rise up at the shorter side of the rectangular first section of the particular substrate. The arrester advantageously does not extend over the entire side.

The arresters of the first electrodes suitably extend in the electrode stack in a direction that is referred to as the longitudinal direction and that is perpendicular to the stacking direction, away from the first section of the particular substrate, and the arresters of the second electrodes extend opposite the longitudinal direction, away from the first section of the particular substrate. Thus, the arresters of the first electrodes are situated one on top of the other in the stacking direction, and the arresters of the second electrodes are situated one on top of the other in the stacking direction. The arresters of the first electrodes are situated at the side of the electrode stack referred to as the first end-face side, and the arresters of the second electrodes are situated at the second end-face side of the electrode stack which is opposite the first end-face side, i.e., oriented in parallel thereto and perpendicular to the stacking direction.

In summary, the arresters of the first electrodes are situated at the first end-face side of the electrode stack, and the arresters of the second electrodes are situated at the second end-face side opposite the first end-face side.

According to the method, the arresters of the first electrodes can be compacted. The arresters are thus compressed and/or pressed in the stacking direction. A clamping tool, for example, is used for this purpose. Alternatively or additionally, an ultrasonic tool is used for the compaction. For example, in addition to the compaction, pre-fixing of the arresters to one another takes place by ultrasonically welding the arresters together, only in sections or at points.

The compacted arresters of the first electrodes are then advantageously trimmed, i.e., cut to size, in particular cropped. A portion of the compacted section is removed, so that the free ends of the arresters align with one another in the stacking direction.

The compacted (and optionally trimmed) arresters of the first electrodes are subsequently welded to a contact plate that is electrically conductive. In particular, the arresters are ultrasonically welded to the contact plate. For this purpose, the compacted area of the arresters is brought between the contact plate and a sacrificial plate, so that the ultrasonic welding tools contact only the contact plate or the sacrificial plate.

The contact plate and/or the sacrificial plate are/is made of aluminum or copper, for example.

The contact plate can be subsequently welded, in particular laser-welded, to a contact element of a cell cover of a cell housing. The contact plate is preferably situated directly at the contact plate. The contact element is advantageously situated at the side of the contact plate facing away from the arresters and optionally the sacrificial plate. The contact element thereby particular preferably forms a terminal of the battery cell. In other words, the contact element is electrically and/or mechanically contactable from the outside of the battery cell. In other words, the contact element protrudes through the cell cover. The welding of the contact plate thus takes place at a cell interior of the contact element.

In summary, the contact element can be electroconductively connected to the arresters by means of the contact plate.

In particular, the contact element can have a one-piece, i.e., monolithic, design. In addition, the cell cover is advantageously designed as an assembly, i.e., is preassembled. Thus, the cover does not have to be installed or assembled after the welding.

The cell cover can then be preferably arranged at the first end-face side of the electrode stack. Thus, in the installed state the cell cover conceals the end-face side with respect to the longitudinal direction. For this purpose, the arresters of the first electrodes, in particular in their uncompacted area, are bent in such a way that after the bending, the cell cover conceals the end-face side of the electrode stack. Thus, the arresters of the first electrodes are bent in such a way that the cell cover, in particular its outer side, is oriented in parallel to the first end-face side. The bending (turning down) advantageously takes place by means of at least one blade. In summary, the inner side of the contact element, i.e., the side of the contact element to which the contact plate is welded, is shifted with respect to the first end-face side due to the bending.

Due to the rigidity of the contact plate and/or the sacrificial plate, and thus due to the accompanying rigidity of the arresters in their section joined thereto, it is advantageously made possible for the arresters to be turned down by means of only a single blade. For this purpose, the blade extending in the transverse direction is advantageously moved against the arresters, i.e., onto the top side of the arresters in their unwelded section, in a direction opposite the stacking direction.

To form the electrode stack (before it is provided, i.e., before the arresters of the first electrodes are welded), two separate single stacks can be stacked on top of one another. Each of the single stacks includes first electrodes and second electrodes stacked one on top of the other. The first and second electrodes are fixed to one another using adhesive tape (fixing tape), for example. For example, each of the single stacks includes between 50 and 200, in particular 100, first electrodes and between 50 and 200, in particular 100, second electrodes.

Thus, the two single stacks are stacked one on top of the other to form the electrode stack in such a way that the arresters of the first electrodes and the arresters of the second electrodes are in each case arranged one on top of the other in the stacking direction. The arresters of the first electrodes are subsequently compacted, preferably trimmed, and welded together.

A difference in the positioning of the electrodes relative to one another when the electrode stack is formed from single stacks is advantageously less than when a (single) electrode stack is formed with a correspondingly larger number of electrodes.

As an alternative to forming the electrode stack by stacking the two single stacks one on top of the other, the electrode stack is produced by so-called “butterfly welding.” The single stacks are first placed next to one another so that their end-face sides with the arresters of the first electrodes lie opposite one another, i.e., face one another, with the single stacks being inclined one on top of the other. In particular, the arresters of the two single stacks are arranged next to one another in such a way that the topmost arrester of the first single stack, i.e., the arrester facing the second single stack, is situated at the topmost arrester of the second single stack, i.e., at the arrester facing the first single stack. The arresters of the first electrodes are then welded together, advantageously by ultrasonic welding. One of the single stacks is then folded onto the other single stack to form the electrode stack. In this variant, the compaction of the arresters may, and advantageously is, omitted before welding to the contact plate.

The upper arrester with respect to a vertical stacking direction and/or the lower arrester with respect to the vertical stacking direction can be provided with an electrically insulating protective foil, in particular by adhesive bonding. Damage to the arresters during assembly of the battery cell, in particular when the arresters are bent, is thus advantageously avoided, or the risk is at least reduced. In addition, contact of the bent-over arresters with the edges of the second electrodes at the first end-face side is avoided.

The particular protective foil can overhang the arresters in a transverse direction oriented perpendicularly to the longitudinal direction and to the stacking direction. In other words, the protective foils overhang the arresters laterally, i.e., along the short edge of the first sections of the substrates. For a comparatively secure hold, the protective foils are likewise fastened, in particular adhesively bonded, to the top side of the electrode stack or to the bottom side of the electrode stack in sections, in particular on the end with respect to the longitudinal direction.

The top side can be understood to mean the upper side of the electrode stack with respect to the stacking direction, and the bottom side is understood to mean the lower side of the electrode stack with respect to the stacking direction. The top side and the bottom side are oriented perpendicularly to the stacking direction.

A welding strip in particular can be used as the protective foil.

A stopper frame that covers the first end-face side can be advantageously provided for the battery cell. According to one advantageous refinement of the method, the contact plate that is welded to the arresters, before they are welded to the contact plate, is led through a passage in the stopper frame which in particular is hole-like, i.e., passes through in the longitudinal direction. The stopper frame is preferably situated at the first end-face side, and in particular is placed on the first end-face side, i.e., pushed onto the first end-face side. Thus, after the stopper frame is placed at the first end-face side, the contact plate and the arresters overhang the passage.

The stopper frame and the electrode stack can be advantageously fixed by means of a fixing foil. For this purpose, for example the fixing foil is wrapped around the electrode stack and the stopper frame. The fixing foil is then advantageously joined to the stopper frame, in particular heat-staked or welded. The fixing foil is suitably electrically insulating.

A housing shell of a cell housing can be pushed over the contact plate and over the electrode stack. This method step advantageously takes place before the contact plate is welded to the contact element. In this way the electrode arrangement is accommodated in the cell cup that delimits the cell interior. The housing shell is made of sheet metal, in particular aluminum. The housing shell collectively forms the side walls of the housing of the battery cell, which are oriented in parallel to the longitudinal direction. Together with the cell cover or a cell base, the housing shell forms a so-called cell cup. The housing shell thus has a hollow cylindrical design, with the cylinder having a rectangle as the base area.

In particular, as a result of using the contact plate an electrical connection of the arresters to the contact element (by means of the contact plate) is made possible, even with the housing shell already pushed on, and thus with a comparatively small installation space.

The cell cover can be situated on the free end side of the housing shell, and in particular rests against it. The free end side of the housing shell is the side that is oriented perpendicularly to the longitudinal direction, i.e., perpendicularly to the direction of extension of the housing shell. The cell cover thus conceals the housing shell with respect to the longitudinal direction, and in particular the cell cover in the installed state is aligned with the housing shell with respect to the longitudinal direction. For example, the stopper frame forms a stop or a support for the cell cover. In particular, the stopper frame forms a spacer element that keeps the cover spaced apart from the electrode stack.

In summary, the cell cover closes an opening in the housing shell.

If the welding of the contact plate to the contact element takes place after the contact plate and the electrode stack are led through the housing shell, the comparatively complicated leading through of the cell cover, which is larger than the opening in the cell cup, is avoided. The risk of damage to one of the components of the battery cell is also thus reduced.

To arrange the cell cover that is welded to the contact plate, and thus close the housing shell, the arresters are bent as described above, for example by means of a blade.

Before the cell cover is arranged at the first end-face side by bending the arresters, the weld seam resulting from welding the contact plate to the contact element can be advantageously covered by a further protective foil. For this purpose, the further protective foil is, for example, adhesively bonded to the contact plate. The further protective foil covers at least the weld seam, and preferably also the sacrificial plate. During arrangement of the cell cover, damage to the arresters due to welding residues, a sharp edge, or a burr on the weld seam is prevented by the further protective foil.

A further aspect of the invention relates to a prismatic battery cell that has been manufactured according to the method in one of the variants described above. The battery cell thus includes an electrode stack with first second electrodes advantageously stacked one on top of the other in alternation. The arresters of the first electrodes are arranged at a (first) end-face side of the electrode stack. The arresters are compacted and welded to a contact plate, in particular by ultrasonic welding, with the contact plate in turn being welded, in particular laser-welded, to a contact element of a cell cover.

The electrode stack in turn can be formed by two single stacks stacked one on top of the other.

The upper arrester with respect to the vertical stacking direction and/or the lower arrester with respect to the vertical stacking direction are/is preferably provided with an in particular electrically insulating protective foil.

The arresters can be led through a passage in a stopper frame situated at the (first) end-face side of the electrode stack.

The electrode stack and the stopper frame can be fixed to one another by means of a fixing foil.

A housing shell of a cell housing can be pushed over the contact plate and the electrode stack (and the stopper frame, if present). In the installed state the contact plate and the electrode stack are situated in the housing interior, and thus in the spatial area encompassed by the housing shell.

The cell cover can be situated at the (first) end-face side of the electrode stack. The cell cover advantageously rests against the stopper frame. The stopper frame is thus situated between the cell cover and the end-face side of the electrode arrangement. The cell cover is particularly preferably situated at the free end side of the housing shell, thus covering it in a direction parallel to a center axis of the housing shell.

The weld seam resulting from welding the contact plate to the contact element can be covered by a further protective foil, in particular adhesively bonded thereto.

A further aspect of the invention relates to an electrically driven motor vehicle having a prismatic battery cell that is designed according to one of the above-described variants and/or that has been manufactured according to the method in one of the above-described variants.

In particular, the motor vehicle can include a traction battery (HV battery) that is provided and configured to provide electrical energy for a traction drive. The prismatic battery cell is part of the traction battery.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flow chart that represents a method sequence for manufacturing a battery cell,

FIG. 2 schematically shows a perspective view of two single stacks that are stacked one on top of the other to form an electrode stack,

FIG. 3 schematically shows a perspective view of the electrode stack, with its second arresters contacted with a cell base,

FIG. 4 schematically shows a detail of a side view of compacted first arresters of the electrode stack, with the first arresters ultrasonically welded to a contact plate,

FIG. 5 schematically shows a perspective view of the electrode stack, with a stopper frame pushed over the contact plate,

FIG. 6 schematically shows a perspective view of the electrode stack, the stopper frame, and the cell base that are fixed by means of a fixing foil,

FIG. 7 schematically shows a perspective view of a housing shell that is pushed over the stopper frame and the electrode stack,

FIG. 8 schematically shows a perspective view of the contact plate that is laser-welded to a contact element of a cell cover,

FIG. 9 schematically shows a perspective view of the contact plate covered with a further protective foil,

FIG. 10 schematically shows a perspective view of the battery cell, with the cell cover closing the housing shell, and

FIG. 11 shows a cross-sectional view of the cell cover.

### DETAILED DESCRIPTION

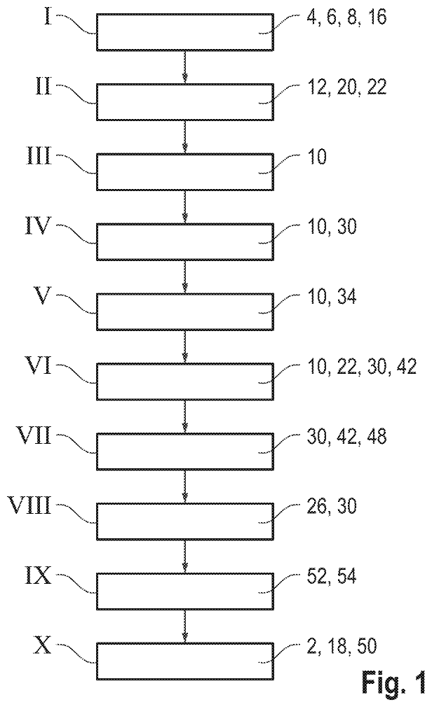

FIG. 1 illustrates a method for manufacturing a prismatic battery cell 2, in particular designed as a lithium-ion battery cell, with reference to a flow chart.

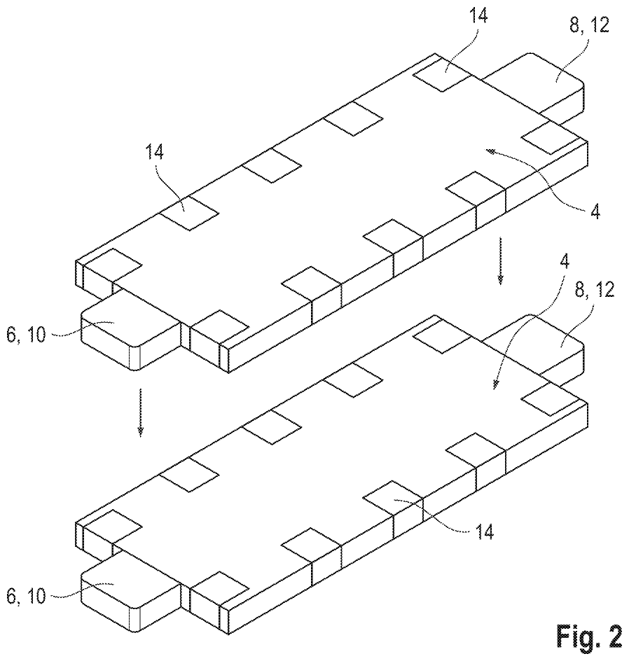

In the method, two separate single stacks 4 (single electrode stacks 4) are stacked one on top of the other in a first step I. This is represented by an arrow in FIG. 2.

Each of the single stacks 4 includes a plurality of first electrodes 6 and second electrodes 8 that are stacked one on top of the other in alternation in a stacking direction S, with a separator situated in each case between the first electrode and the second electrode.

The first and second electrodes 6, 8 of each single stack 4 have a sheet-like design. Each includes a foil-like substrate with a rectangular section coated with active material, and an arrester 10. In the following discussion, for better differentiation the arresters of the first electrodes 6 are referred to as first arresters 10, and the arresters of the second electrodes 8 are referred to as second arresters 12. The first and second arresters 10, 12 rise up at the shorter side of the rectangular coated section. For each of the single stacks 4, the first arresters 10 are arranged one on top of the other and the second arresters 12 are arranged one on top of the other, with the first arresters 10 rising up in a longitudinal direction L with respect to the first section, and the second arresters 12 rising up opposite the longitudinal direction L with respect to the section of the particular substrate.

For each of the single stacks 4, a fixing tape 14 is used to fix the electrodes 6, 8 of the respective single stack 4. The fixing tape 14 is adhesively bonded to an upper (top) side of the particular single stack 4 with respect to the stacking direction S, and to the lower (bottom) side of the particular single stack 4 with respect to the stacking direction S, and overhangs a side of the particular single stack 4 oriented in parallel to the stacking direction S.

In the first step I, the two single stacks 4 are arranged one on top of the other in such a way that the arresters 10 of first electrodes 6 of both single stacks 4 are situated one on top of the other in the stacking direction S. Similarly, the arresters 12 of the second electrodes 8 of both single stacks 4 are situated one on top of the other in the stacking direction S.

As a result of stacking the two single stacks 4 on top of one another, the first arresters 10 are situated on one side of the electrode stack 16 that is formed, referred to as the first end-face side 18. The second arresters 12 are situated on the second end-face side 20 of the electrode stack 16 opposite the first end-face side 18, i.e., oriented in parallel thereto and perpendicular to the stacking direction S.

The two single stacks 4 stacked on top of one another are advantageously fixed to one another by means of a fixing tape 14.

In summary, stacking the two single stacks 4 on top of one another results in the electrode stack 16 that is provided for the further manufacture of the battery cell 2.

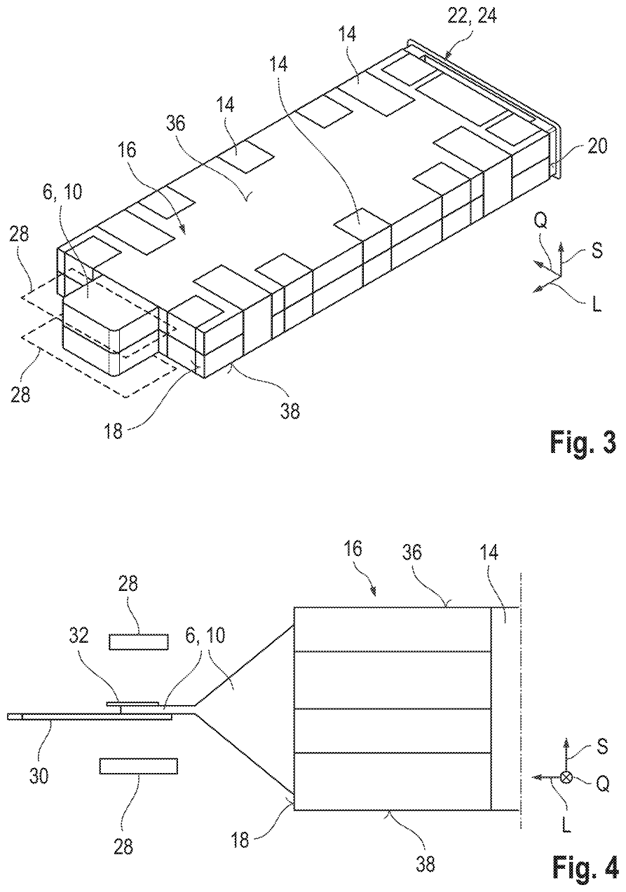

The arresters 12 of the second electrodes 8 are connected to a cell base 22 of a cell housing 24 in a subsequent second step II. For example, for this purpose the arresters 12 of the second electrodes 8 are compacted and then trimmed. For example, the arresters 12 are ultrasonically welded in the course of the compaction. The arresters 12 of the second electrodes 8 are subsequently welded, for example by laser welding, to a contact element of the cell base 22. The cell base 22 is advantageously situated on the second end-face side 20 of the electrode stack 16, in particular by bending the arresters 12 of the second electrodes 8. The cell base 22 situated on the second end-face side 20 is illustrated in FIG. 3, for example.

The first arresters 10 are compacted in a subsequent third step III (also see FIG. 3). An ultrasonic tool in particular is used for this purpose, with the first arresters 10 being pressed together. For example, the first arresters 10 are pre-fixed by means of the ultrasonic tools 28, in particular by ultrasonic welding in sections or at points. The ultrasonic tools 28 are only schematically indicated by rectangles in FIG. 3. The free end of the arrester packet made up of the compacted first arresters 10 is subsequently cropped to a predefined length.

The compacted and trimmed first arresters 10 are ultrasonically welded to a contact plate 30 in a subsequent fourth step IV, as illustrated in FIG. 4. For this purpose, the compacted area of the first arresters 10 is introduced between the contact plate 30 and a sacrificial plate 32. During the ultrasonic welding, the ultrasonic tools 28 then bring about contact only with the contact plate 30 and the sacrificial plate 32, thus avoiding damage to the first arresters 10.

The upper first arrester 10 with respect to a vertical stacking direction Z and/or the lower first arrester 10 with respect to the vertical stacking direction Z are/is provided with an electrically insulating protective foil 34 in a subsequent fifth step V.

The protective foil 34 overhangs the first arresters 10 in a transverse direction Q oriented perpendicularly to the longitudinal direction L and to the stacking direction S. The protective foil thus laterally overhangs the arresters 10. For a comparatively secure hold, the protective foils are likewise fastened, in particular adhesively bonded, to the top side 36 of the electrode stack or to the bottom side 38 of the electrode stack in sections, in particular on the end with respect to the longitudinal direction. In other words, at the top side 36 or at the bottom side 38 of the electrode stack 4 the protective foil 34 in each case extends across the edge area of the electrode stack 16 at which the respective arrester 10 is situated.

The top side 36 is understood to mean the upper side of the electrode stack 16 with respect to the stacking direction S, and the bottom side 38 is understood to mean the lower side of the electrode stack 16 with respect to the stacking direction S. The top side 36 and the bottom side 38 are oriented perpendicularly to the stacking direction S.

A welding strip in particular is used as the protective foil 34.

The protective foil 34 mounted on the top side 36 is apparent in FIG. 5, for example.

In a subsequent sixth step VI (also see FIG. 5), the contact plate 30 that is welded to the first arresters 10 is led through a passage 40 in a stopper frame 42 that passes through in the longitudinal direction L. In other words, the stopper frame 42 is pushed over the contact plate 30 and the arresters 10 so that the contact plate 30 and the arresters 10 pass through the passage 40 in the stopper frame 42.

The stopper frame 42 is situated on the first end-face side 18. The stopper frame 42 is pushed onto the electrode stack 4. The stopper frame 42 is situated on the first end-face side 18, so that the stopper frame 42 covers the electrode stack 16 with respect to the longitudinal direction L.

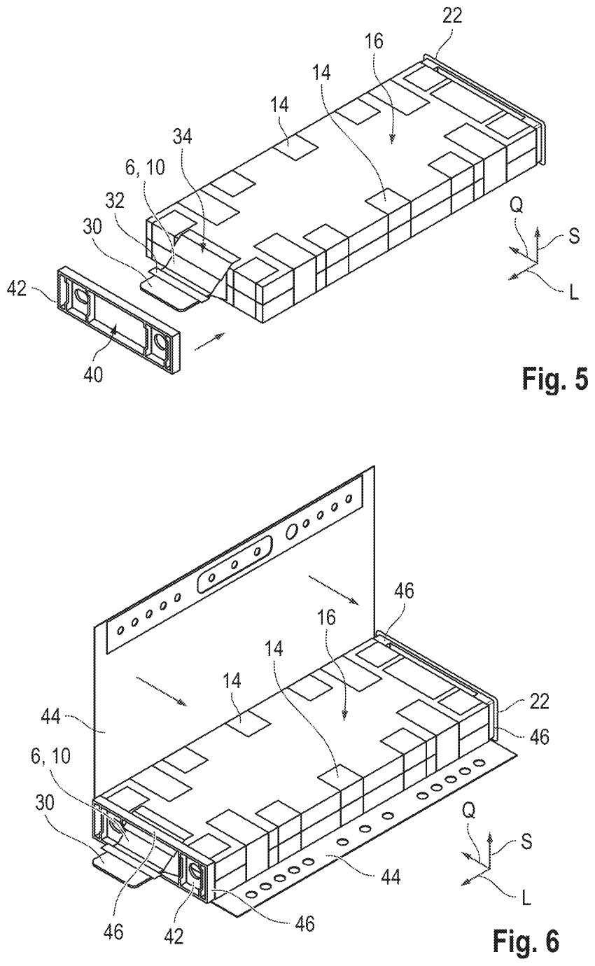

The stopper frame 42, the cell base 22, and the electrode stack 16 are subsequently fixed to one another by means of an advantageously electrically insulating fixing foil 44. For this purpose, the fixing foil 44 is wrapped around the electrode stack, around the side faces 46 of the cell base 22 oriented in parallel to the longitudinal direction L and of the stopper frame 42 (also see FIG. 6). For example, after the wrapping operation the fixing foil 44 is fixed by means of an adhesive tape 30. In addition, the fixing foil 44 is welded or joined by heat staking to the cell base 22 and to the stopper frame 42 at its side faces 46 oriented in parallel to the longitudinal direction L.

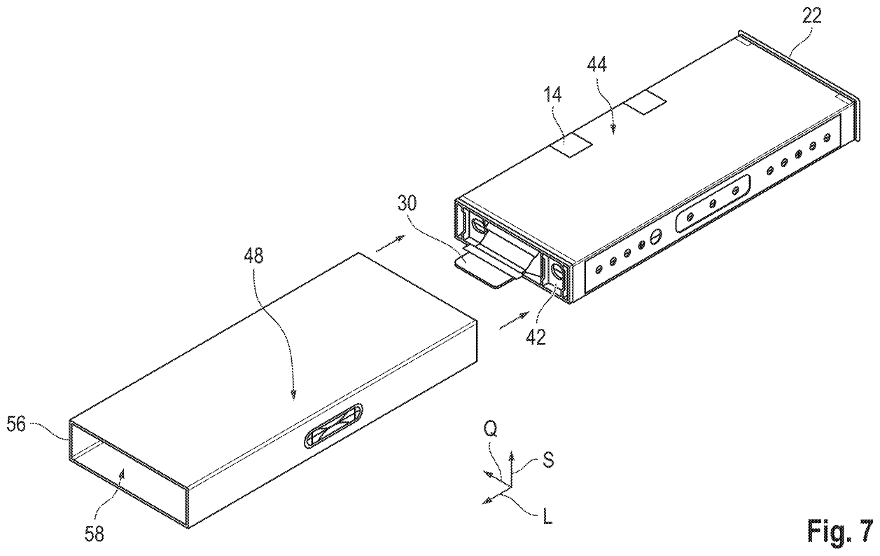

In a subsequent seventh step VII a housing shell 48 of the cell housing 24 is pushed over the contact plate 30, the stopper frame 42, and the electrode stack 4 (also see FIG. 7). The housing shell 48 encompasses the cell interior, and thus forms the side walls of the cell housing 24 oriented in parallel to the longitudinal direction L. The housing shell 48 is thus designed as a hollow prism (a hollow cylinder with a rectangular base area).

The electrode stack 4 and the stopper frame 42 are situated in the housing shell 48, i.e., are accommodated inside the spatial area encompassed by the housing shell 48.

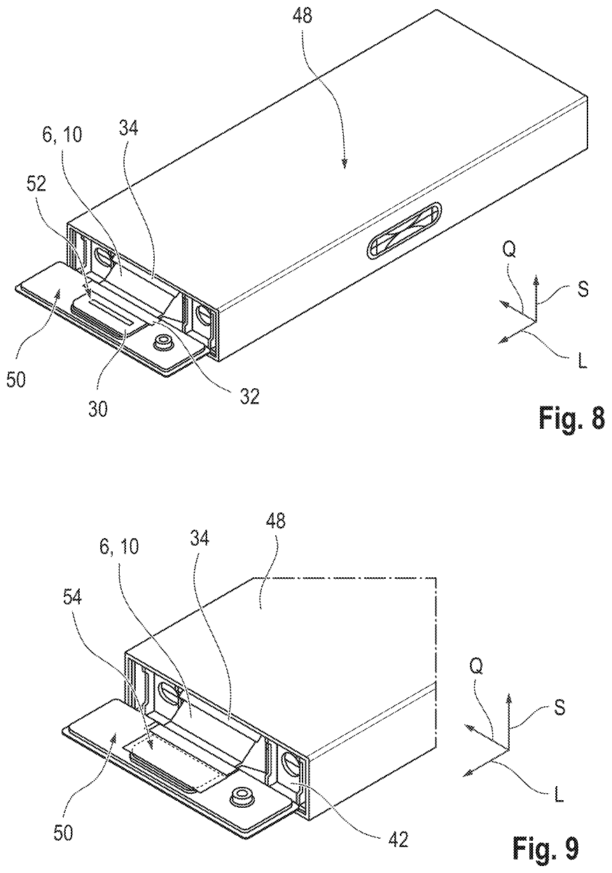

In a subsequent eighth step VIII the contact plate 30 is laser-welded to a contact element 26 of a cell cover 50 (also see FIG. 8). The contact element 26 thus forms a terminal of the battery cell 2; i.e., the contact element 26 is electrically and/or mechanically contactable from outside the battery cell 2 (see FIG. 11). The welding of the contact plate 30 thus takes place at a cell interior of the contact element 26.

In summary, the contact element 26 is electroconductively connected to the first arresters 10 by means of the contact plate 30.

The cell cover 50 is designed as an assembly, i.e., is preassembled. Thus, the cell cover thus only needs to be attached.

In a subsequent ninth step IX the weld seam 52 resulting from the welding of the contact plate 30 to the contact element 26 is covered by a further protective foil 54 (also see FIG. 9). In particular, the entire contact plate 30 on its cell interior side as well as the sacrificial plate 32 are adhesively bonded to the further protective foil 54. Damage to the first arresters 10 in particular due to welding residues or on account of the weld seam 52 itself is thus avoided.

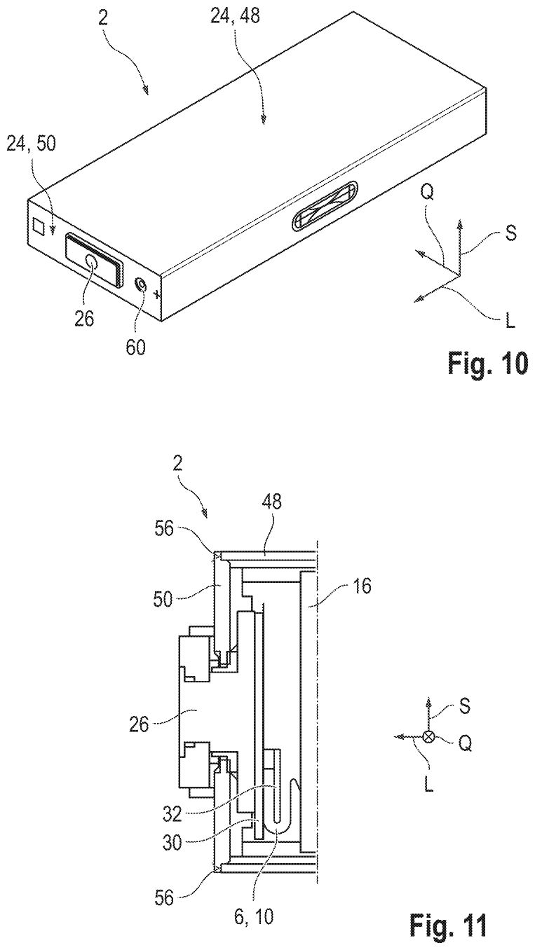

In a subsequent tenth step X the cell cover 50 is arranged on the free end side 56 of the housing shell 48 (also see FIG. 10). As a result, the cell cover 50 rests on the free end side 56. The free end side 56 is understood to mean the side face of the housing shell 48 that is oriented perpendicularly to the longitudinal direction L, and thus perpendicularly to the direction of extension or center axis of the housing shell 48.

The cell cover 50 is thus situated in such a way that it conceals the stopper frame 42 and the first end-face side 18 of the electrode stack 16. The cell cover 50 thus closes the opening 58 in the housing shell 48. For this purpose, the first arresters 10, in particular in their uncompacted area, are appropriately bent, in particular folded over and/or driven in. In the sectional view according to FIG. 11, the first arresters bent in this manner are discernible in particular through the cell cover 50 situated at the housing shell 48. In summary, the inner side of the contact element, i.e., the cell interior of the contact element 26 to which the contact plate 30 is welded, is tilted toward the first end-face side 18 due to the bending.

Analogously, the cell base 22 is situated on the other free end side 56 of the housing shell 48.

The cell base 22 and the cell cover 50 are advantageously welded, in particular laser-welded in a fluid-tight manner, to the housing shell 48 so that a cuboidal cell housing is formed.

The battery cell 2 is then advantageously filled with an electrolyte through a filling opening 60 situated in the cell cover 50. The filling opening 60 is subsequently closed by means of a pin, for example, that in particular is made of an elastomer. The filling opening 60 and the pin accommodated therein are subsequently covered by a cover, for example, in particular made of metal, and welded to the outer wall of the cell cover 50. The filling opening 60 is thus closed in a seal-tight manner.

An electrically driven motor vehicle, in particular its traction battery, includes the battery cell 2.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing a prismatic battery cell, the method comprising:
providing an electrode stack having first electrodes and second electrodes stacked one on top of the other, arresters of the first electrodes rise up at an end-face side of the electrode arrangement;
compacting the arresters of the first electrodes;
welding the compacted arresters to a contact plate; and
welding the contact plate to a contact element of a cell cover.

2. The method according to claim 1, wherein, for forming the electrode stack, two separate single stacks, each having first electrodes and second electrodes that are stacked one on top of the other and fixed to one another, are stacked one on top of the other.

3. The method according to claim 1, wherein the upper arrester with respect to a vertical stacking direction and/or the lower arrester with respect to the vertical stacking direction are provided with an electrically insulating protective foil.

4. The method according to claim 1, wherein the contact plate that is welded to the arresters, before it is welded to the contact plate, is led through a passage in a stopper frame, and/or wherein the stopper frame is arranged on the end-face side.

5. The method according to claim 4, wherein the electrode stack and the stopper frame are fixed to one another via a fixing foil.

6. The method according to claim 1, wherein a housing shell of a cell housing is pushed over the contact plate and over the electrode stack.

7. The method according to claim 6, wherein the cell cover is arranged on a free end side of the housing shell.

8. The method according to claim 1, wherein a weld seam resulting from the welding of the contact plate to the contact element is covered by a further protective foil.

9. A battery cell that is manufactured by the method according to claim 1.

10. A motor vehicle comprising the battery cell according to claim 9.
